(19) United States
(12) Patent Application Publication
(10) Pub. No.: US 2011/0138663 A1
(43) Pub. Date: Jun. 16, 2011

(54) MODULAR LED LIGHT-EMITTING MARKER

(75) Inventor: Yi-Quin CHEN, Taichung City (TW)

(73) Assignee: SAFETY TRAFFIC EQUIPMENT Co., Ltd., Taichung City (TW)

(21) Appl. No.: 12/639,564

(22) Filed: Dec. 16, 2009

(51) Int. Cl. G09F 13/00; F21V 7/00; G09F 13/16

(52) U.S. Cl. 40/541; 362/296.01

(57) ABSTRACT

A modular LED light-emitting marker having a pedestal with a back side, a light-emitting marking side and a holding space. At least a LED circuit board is accommodated into the holding space of the pedestal. The LED circuit board contains a LED setup surface, which faces the light-emitting marking side of the pedestal. The LED circuit board also contains an electrical connecting line penetrating out of the pedestal. A waterproof cladding is assembled between the LED circuit board and the pedestal, and used to fully seal the LED circuit board. A reflecting surface is set onto the light-emitting marking side of the pedestal. The reflecting surface is provided with LED through-holes. A protruding LED unit is arranged onto the LED setup surface The exterior of the protruding LED unit is protruded out of the waterproof cladding and reflecting surface.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a light-emitting marking mechanism, and more particularly to an innovative one which is configured into a modular LED light-emitting marker.

2. Description of Related Art Including Information Disclosed Under 37 CFR 1.97 and 37 CFR 1.98.

The currently available traffic marking panels and other indicating or labeling panels (hereinafter collectively referred to as marking panel) are generally combined with LED components for highlighting their letters and patterns in an energy-saving and cost-efficient way.

The LED components on the surface of conventional marking panel are generally arranged in such a manner that LED components along with the circuit board are firstly fabricated into a platy light-emitting unit, and then adhered securely onto the letters and patterns of the marking panel. Yet, it is observed during actual applications that, since LED light-emitting units are fixed onto the surface of conventional marking panel, when replacement is required in the event of any damage, this will lead possibly to peeling-off of the letters and patterns if removing the defective light-emitting units.

Moreover, the technical problem for the industrial operators is how to optimize the light-emitting efficiency of LED units with satisfactory waterproofing and robustness.

Moreover, the disassembly and repair convenience of connecting lines for various light-emitting units has to be considered.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production, development and design of related products.

### BRIEF SUMMARY OF THE INVENTION

The enhanced efficacy of the present invention is as follows:

Based on the unique structural configuration of the present invention that the “modular LED light-emitting marker” mainly includes a pedestal, LED circuit board, waterproof cladding, reflecting surface and protruding LED unit, said protruding LED unit is protruded out of the waterproof cladding and reflecting surface, thus ensuring the luminance gain from straight and lateral radiation of rays. Moreover, the LED circuit board is fully sealed by the waterproof cladding to realize excellent waterproofing, protect efficiently the LED circuit board against moisture and extend the service life. With this configuration, the modular LED light-emitting markers can be operated in a manner to optimize the light-emitting efficiency with strong waterproofing and robustness.

The improvements brought about by this invention are as follow:

Based on the structural configuration of the setting portion of the rail-mounted rack, the modular LED light-emitting markers could slide along the rail, and the spacing among them can be adjusted. Moreover, the quantity of modular LED light-emitting markers is not limited, enabling more flexible assembly of the modular LED light-emitting markers to meet the diversified demands.

As the electrical connecting line is provided with a quick-release electrical connector that contains male and female conductive contacts, the circuits of modular LED light-emitting markers can be quickly removed and assembled with improved applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 a perspective view of the assembled preferred embodiment of the present invention.

FIG. 2 shows an exploded perspective view of the preferred embodiment of the present invention.

FIG. 3 shows a cross sectional view of the assembled preferred embodiment of the present invention.

FIG. 4 shows a perspective view of the present invention that the preferred embodiment is assembled onto the rail-mounted rack.

FIG. 5 shows a cross sectional view of the present invention that the preferred embodiment is assembled onto the rail-mounted rack.

FIG. 6 shows a schematic view of the electrical connecting line of the present invention is fitted with a quick-release electrical connector.

FIG. 7 shows a schematic view of the present invention as applied to the traffic marking panel.

FIG. 8 shows the other schematic view of the present invention as applied to the traffic marking panel.

### DETAILED DESCRIPTION OF THE INVENTION

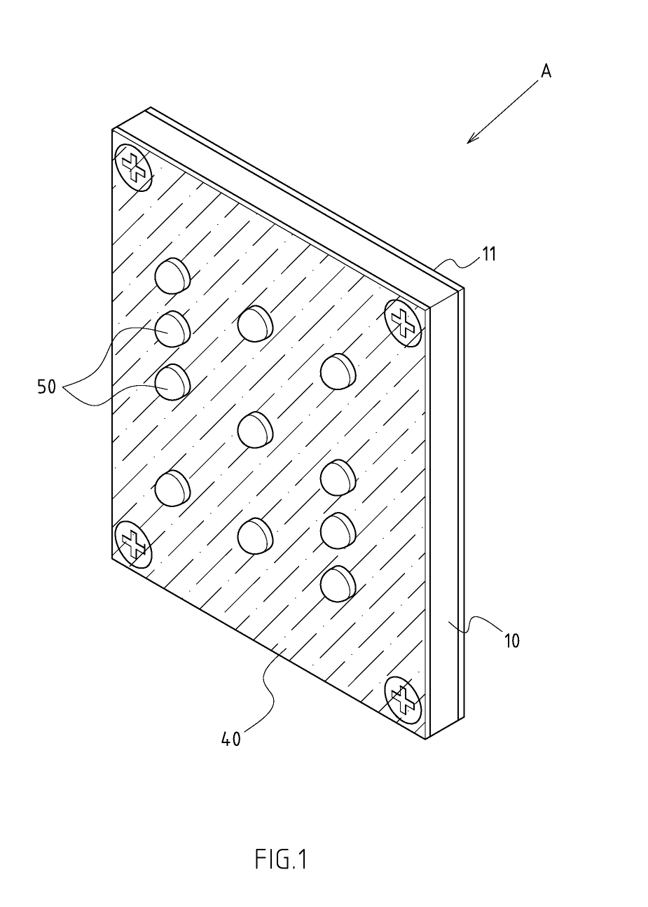

FIGS. 1-3 depict preferred embodiments of a modular LED light-emitting marker A of the present invention, which are provided for only explanatory objective for patent claims. Said modular LED light-emitting marker A includes pedestal 10, comprising a back side 11, a light-emitting marking side 12 and a holding space 13 arranged between the back side 11 and light-emitting marking side 12.

At least one LED circuit board 20 is accommodated into the holding space 13 of the pedestal 10. The LED circuit board 20 contains a LED setup surface 21, which faces the light-emitting marking side 12 of the pedestal 10. The LED circuit board 20 also contains an electrical connecting line 22 penetrating out of the pedestal 10.

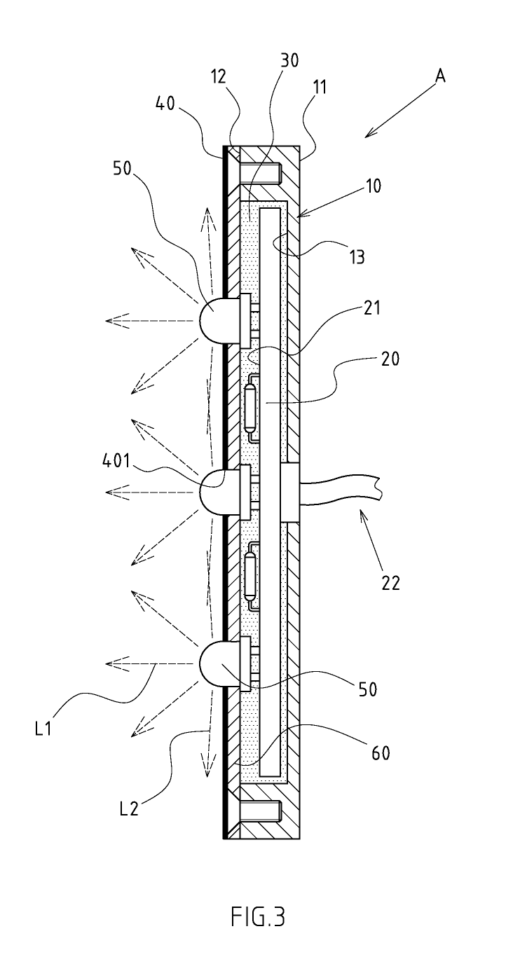

A waterproof cladding 30, shown in FIG. 3, is assembled between the LED circuit board 20 and the pedestal 10, and used to fully seal the LED circuit board 20 and protect it against any moisture. The waterproof cladding 30 is made of waterproof glue.

A reflecting surface 40 is set onto the light-emitting marking side 12 of the pedestal 10. The reflecting surface 40 is provided with LED through-holes 401.

At least one protruding LED unit 50 is arranged onto the LED setup surface 21 of the LED circuit board 20. Referring to FIG. 3, the exterior of the protruding LED unit 50 is protruded out of the waterproof cladding 30 and reflecting surface 40, thus ensuring the luminance gain from straight radiation (indicated by arrow L1) and lateral radiation (indicated by arrow L2) of rays.

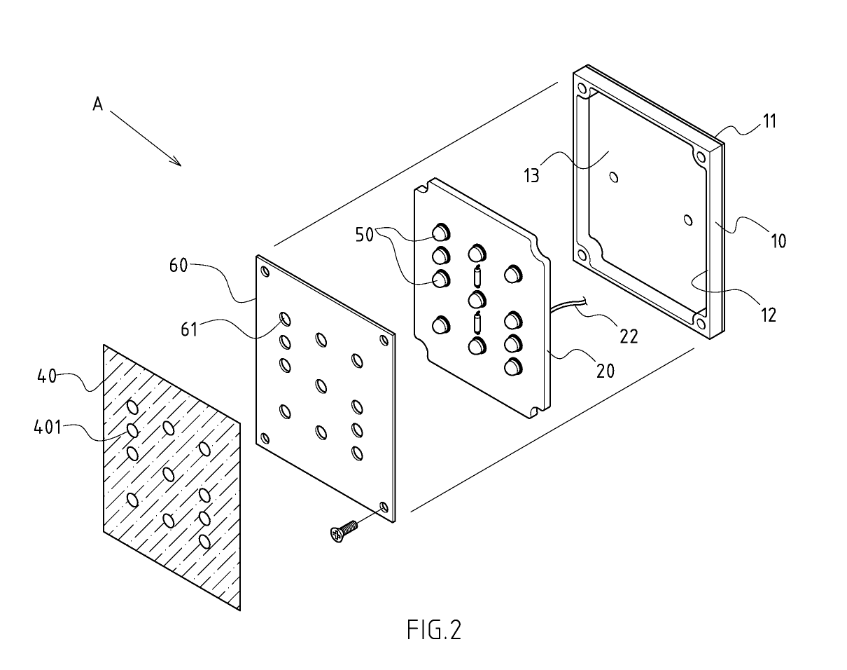

Referring to FIGS. 2 and 3, a faceplate 60 is set at the light-emitting marking side 12 of the pedestal 10, and the reflecting surface 40 is set on the exterior of the faceplate 60. Moreover, the faceplate 60 is provided with through-holes 61 for the protruding LED unit 50.

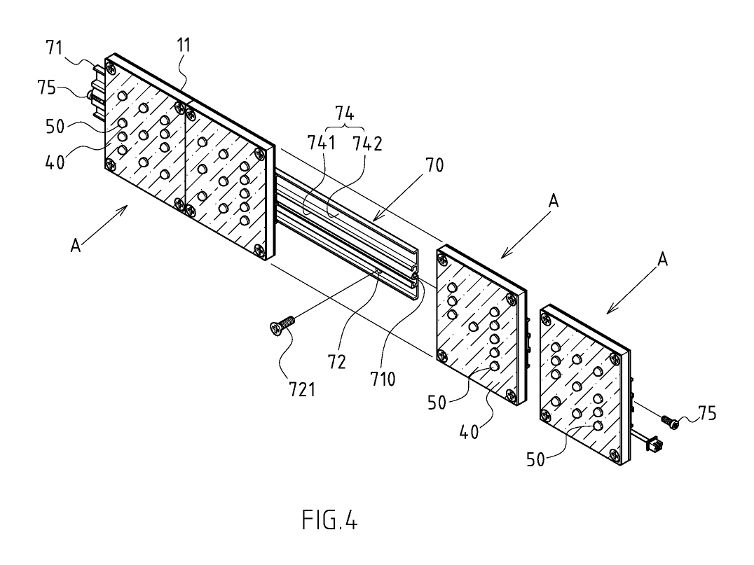

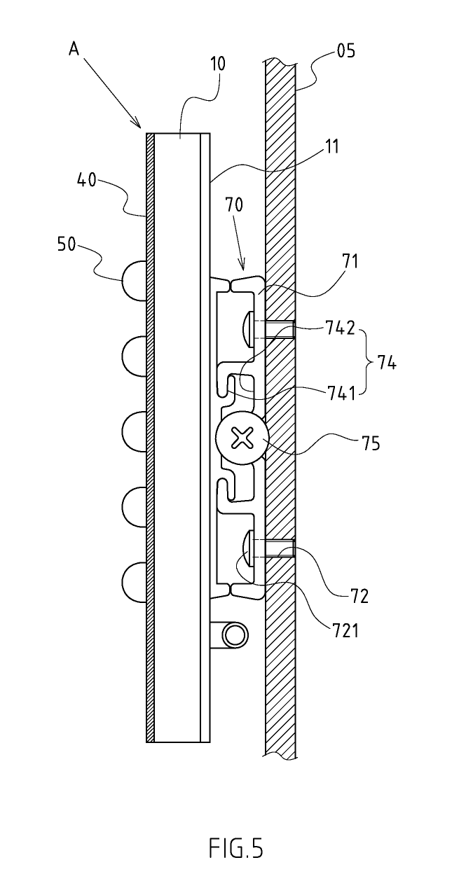

Referring to FIGS. 4 and 5, a plurality of modular LED light-emitting markers A are arranged onto a rail-mounted rack 70. The long type rail-mounted rack 70 is defined to form an extension 71 and the rail-mounted rack 70 comprises an assembly locating portion 72 and a setting portion 74, of which the assembly locating portion 72 is used to assemble and locate the rail-mounted rack 70 onto an object, and the setting portion 74 is used to set up securely the modular LED light-emitting markers A. The setting portion 74 is composed of a rail 742 with interlocking flange 741. The assembly locating portion 72 of the rail-mounted rack 70 is composed of a plurality of through-holes for locking of the object 05 (shown in FIGS. 4 and 5) by the bolt 721.

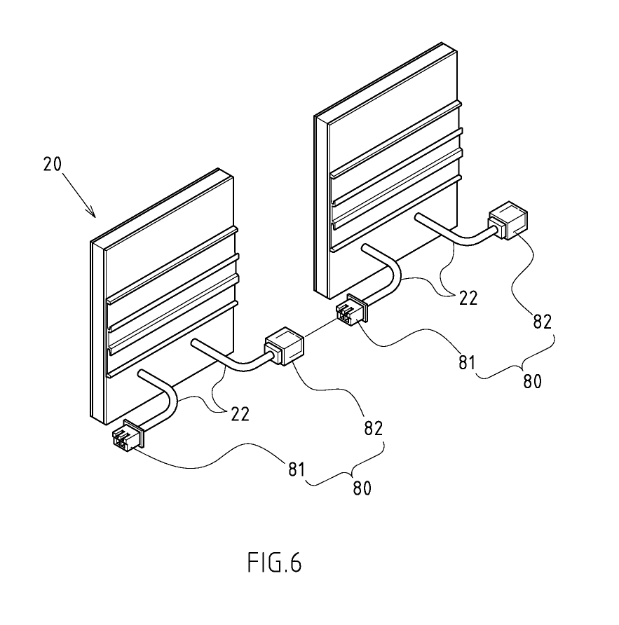

Referring to FIG. 6, the electrical connecting line 22 is provided with a quick-release electrical connector 80, which contains male and female conductive contacts 81, 82 that can be quickly removed and assembled.

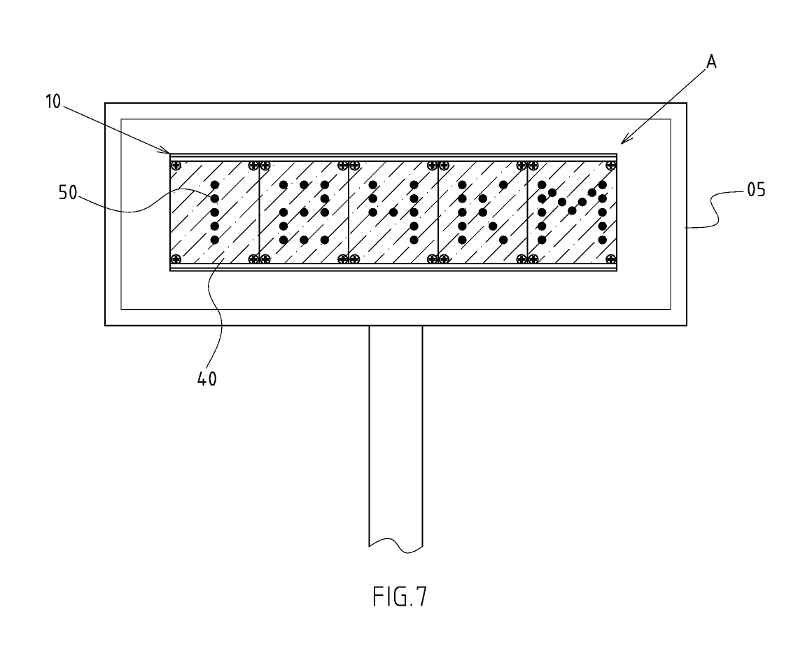

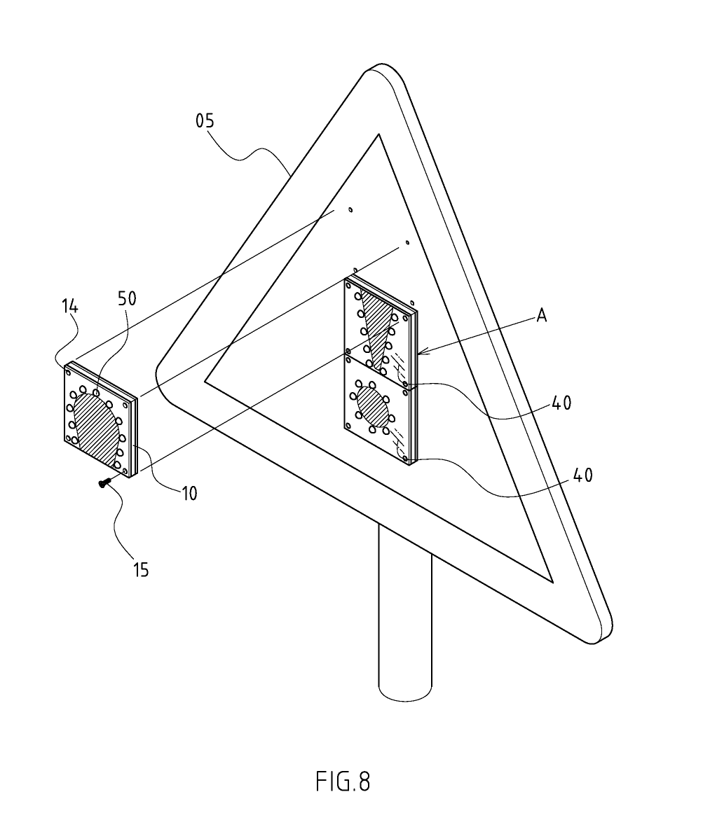

Of which, the pedestal 10 is fitted with a setup locating portion 14 (marked in FIG. 8), thus permitting to directly locate onto the surface of an existing object 05 through a locator 15. The application state of the modular LED light-emitting marker A is shown in FIG. 7, wherein the assembled object 05 is a traffic marking panel indicating the landmarks, mileage or speed limit and name of places on the national highway. The modular LED light-emitting marker A is used for light-emitting marking purpose. Referring to FIG. 8, the existing object 05 is a traffic marking panel or other indicating or labeling panel.

Referring to FIGS. 4 and 5, the extension 71 of the rail-mounted rack 70 is provided with a screw hole 710 for screwing of the bolt 75. So this protruding LED unit 50 can be limited securely by the bolt 75.

Based on the above-specified structural configuration, the core design of the modular LED light-emitting marker A lies in that, the LED unit 50 is protruded out of the waterproof cladding 30 and reflecting surface 40, thus ensuring the luminance gain from straight and lateral radiation of rays. Moreover, the LED circuit board 20 is fully sealed by the waterproof cladding 30 for realizing excellent waterproofing purpose. Based on the structural configuration that the quick-release electrical connector 80 is composed of male and female conductive contacts 81, 82, the circuits between this modular LED light-emitting marker A can be quickly removed and assembled.

1. (canceled)

2. (canceled)

3. (canceled)

4. (canceled)

5. (canceled)

6. (canceled)

7. (canceled)

8. A modular LED light-emitting marker assembly comprising:
a pedestal having a back side and a light-emitting marker side and a holding space, said holding space formed between said back side and said light-emitting maker side;
at least one LED circuit board received into said holding space of said pedestal, the LED circuit board having an LED setup surface facing said light-emitting marker of said pedestal, the LED circuit board having an electrical connecting line extending outwardly of said pedestal, said electrical connecting line having a quick-release electrical connector with a male conductive contact and a female conductive contact;
a waterproof cladding assembled between the LED circuit board and said pedestal so as to seal the LED circuit board in waterproof relation, said waterproof cladding being a waterproof glue;
a faceplate positioned against said light-emitting marker side of said pedestal, said faceplate having through-holes formed therein;
a reflecting surface set onto said light-emitting marker side of said pedestal, said reflecting surface having through-holes formed therein aligned with said through-holes of said faceplate, said reflecting surface affixed to an exterior of said faceplate;
at least one protruding LED unit affixed onto said LED setup surface of said LED circuit board, the LED unit protruding outwardly of said waterproof cladding and outwardly of said reflecting surface through said through-holes of said faceplate and said reflecting surface so as to allow the LED unit to emit straight and lateral radiation of light therefrom; and
an elongated rail-mounted rack having an assembly locating portion and a setting portion, said pedestal being secured to said setting portion, said assembly locating portion suitable for securing said rail-mounted rack to an exterior object or surface.

9. The assembly of claim 8, said pedestal having a setup locating portion suitable for allowing said pedestal to be directly mounted to the exterior object or surface.

10. The assembly of claim 8, the exterior object or surface being a traffic marking panel.
